(19) United States
(12) Patent Application Publication
(10) Pub. No.: US 2016/0003162 A1
(43) Pub. Date: Jan. 7, 2016

(54) DAMPING DEVICE FOR A GAS TURBINE, GAS TURBINE AND METHOD FOR DAMPING THERMOACOUSTIC OSCILLATIONS

(71) Applicant: SIEMENS AKTIENGESELLSCHAFT, Munich (DE)

(72) Inventors: Christian Beck, Essen (DE); Jaap van Kampen, AR Roermond (NL)

(73) Assignee: Siemens Aktiengesellschaft, Munich (DE)

(21) Appl. No.: 14/768,859

(22) PCT Filed: Feb. 28, 2014
(86) PCT No.: PCT/EP2014/053921

§ 371 Date: Aug. 19, 2015

(30) Foreign Application Priority Data
Feb. 28, 2013 (EP) 13157106.9

(51) Int. Cl. F02C 7/24; F02C 7/18; F02C 3/04; F23R 3/00

(52) U.S. Cl. CPC F02C 7/24; F23R 3/005; F02C 7/18; F02C 3/04; F05D 2220/32; F05D 2260/963

(57) ABSTRACT

A damping device for a gas turbine has at least one Helmholtz resonator and at least one duct, wherein the Helmholtz resonator has a resonator housing and at least one resonator neck pipe and the resonator housing encloses a resonance volume of the Helmholtz resonator, into which volume acoustic vibrations can be injected by means of the resonator neck pipe. The damping device enables a particularly effective damping of thermo-acoustic vibrations. For this purpose, the duct is formed with a duct jacket and at least one outlet opening. Acoustic vibrations of a fluid stream flowing through a burner plenum and a combustion chamber can be injected into the outlet opening. A cooling fluid can be applied to the duct and the at least one resonator neck pipe opens on the hot-gas side into such a duct upstream of the at least one outlet opening.

### CROSS REFERENCE TO RELATED APPLICATIONS

This application is the US National Stage of International Application No. PCT/EP2014/053921 filed Feb. 28, 2014, and claims the benefit thereof. The International Application claims the benefit of European Application No. EP13157106 filed Feb. 28, 2013. All of the applications are incorporated by reference herein in their entirety.

### FIELD OF INVENTION

The invention relates to a damping device for a gas turbine with at least one Helmholtz resonator and at least one duct with duct jacketing. The Helmholtz resonator comprises a resonator housing and at least one resonator neck tube, wherein the resonator housing encloses a resonance volume of the Helmholtz resonator into which acoustic oscillations may be injected by means of the resonator neck tube. The duct comprises at least one outlet orifice. The invention also relates to a gas turbine having at least one combustion chamber and at least one such damping device and to a method for damping thermoacoustic oscillations

### BACKGROUND OF INVENTION

In the simplest case, a gas turbine comprises a compressor, a combustion chamber and a turbine. Aspirated air is compressed in the compressor and then admixed with a fuel. In the combustion chamber the mixture is combusted, resulting in a hot working gas stream which is fed to the turbine. The latter extracts energy from the hot working gas and converts it into mechanical energy.

In the combustion chamber interaction may arise between acoustic oscillations and fluctuations in heat release, which may amplify one another. Such thermoacoustic oscillations, which arise in particular in the combustion chamber of the gas turbine, may lead to considerable damage to the components during operation of the gas turbine and force shutdown of the installation.

To reduce thermoacoustic oscillations, therefore, in the prior art Helmholtz resonators are for example used for oscillation damping which effectively damp the oscillation amplitude within a given frequency band.

To prevent hot gas from being drawn into the Helmholtz resonator, purging air is introduced into the resonator neck in the opposite direction from that in which hot gas is drawn in.

EP 0 597 138 A1 discloses a gas turbine combustion chamber. Helmholtz resonators purged with purging air are arranged in the region of the burners. The Helmholtz resonators each comprise a resonator housing, which encloses the resonance volume, and a damping pipe, which may also be denoted a resonator neck tube or resonator neck. The damping pipe connects the resonance volume with the surrounding environment, such that acoustic oscillations can be injected into the resonance volume. A feed pipe introducing purging air leads into the resonator housing, such that the purging air is introduced into the resonance volume and purges the damping pipe in the opposite direction from that in which hot gas is drawn in.

A disadvantage of this method is that the performance of the Helmholtz resonator reduces as the velocity of the purging air in the damping pipe increases. The compressor air used for purging is also not available as combustion air, which has a disadvantageous effect on the emission values achieved by the gas turbine.

### SUMMARY OF INVENTION

An object of the invention is to provide a damping device of the above-stated type and a gas turbine with such a damping device which allows particularly effective damping of thermoacoustic oscillations.

This object is achieved according to the invention in a damping device of the above-stated type in that acoustic oscillations of a fluid stream flowing through a burner plenum and a combustion chamber may be injected into the outlet orifice of the duct and the duct may be supplied with a cooling fluid, wherein the at least one resonator neck tube leads into such a duct on the hot gas side upstream of the at least one outlet orifice.

According to aspects of the invention, the resonator neck tube of the Helmholtz resonator is thus no longer purged, but rather the outlet of the resonator neck tube on the hot gas side leads into a duct supplied with cooling fluid. In this way, the temperature of the medium transmitting the acoustic waves in the mouth area of the resonator neck tube is lowered relative to the temperatures which prevail in the combustion chamber or the burner plenum of the gas turbine. The mouth of the resonator neck tube and the source producing hot, thermoacoustic oscillations are thus always divided by a portion of the duct which is cooled by means of cooling fluid. Only the at least one outlet orifice of the duct may be exposed to the drawing in of hot gas. For example, the duct may be supplied with cooling fluid in such a way that it is purged with purging air in the opposite direction from the direction in which hot gas is drawn in. The duct may however also be cooled in other ways. The only essential thing here is that the duct is supplied with cooling fluid in such a way that the transmission medium for the acoustic oscillations, located inside the duct, is cooled between the outlet orifice and the mouth of the resonator neck tube. For the purposes of the present invention, with regard to the duct “upstream of” denotes a direction which points from the outlet orifice into the duct and in the direction of the mouth of the resonator neck tubes.

According to aspects of the invention, the velocity of purging air through the hot gas-side outlet of the resonator neck tubes may be selected to be significantly lower or the purging air through the resonator neck tube may be dispensed with completely, since the velocity of the acoustic fluctuations in the resonator neck tubes is decoupled from the outlet orifice into a chamber to be damped. The term chamber here means the housing of a combustion chamber or the like which encloses a volume with oscillations to be damped. Drawing in of hot gas into the at least one resonator neck tube is thus reduced or moderated by supply of the at least one duct with cooling fluid. The performance of the Helmholtz resonator, i.e. how powerfully the resonator is able to damp, is in this way no longer impaired.

In this way, damping of the thermoacoustic oscillations may be achieved with fewer such damping devices, whereby additional savings of purging air may be made.

The resonator neck tubes leading into a duct may for example be configured wholly or partly in one piece with the duct, and the duct may for example be configured wholly or partly in one piece with a chamber wall. Chamber wall here means the housing of a combustion chamber or the like in which a volume with oscillations to be damped is enclosed.

According to aspects of the invention, the duct is configured in such a way that acoustic oscillations may be injected into the outlet orifice. This means that at least in one frequency band acoustic oscillations impinging on the outlet orifice propagate at least in part in the duct. The duct may be arranged on or in a gas turbine in such a way that at least one frequency band of the acoustic oscillations of a fluid stream flowing through a burner plenum and a combustion chamber may propagate as far as the outlet orifice of the duct. The term acoustic oscillations is used to denote the thermoacoustic pressure variations arising and building up in gas turbines which may be characteristic of a gas turbine and may form particular preferential frequencies to be damped as a function of the operating point. The thermoacoustic pressure variations may propagate in part as far as into the burner plenum and beyond and are here designated with the phrase “acoustic oscillations of a fluid flowing through a burner plenum and a combustion chamber”. The duct of the damping device according to the invention may for example lead with its at least one outlet orifice directly into the combustion chamber or into the burner plenum. In particular, the duct is different from the burner plenum. The duct does not have to be acoustically transmissive for all the frequencies building up inside the gas turbine. It is sufficient for it to be acoustically transmissive in a suitable frequency band and to be suitably tuned in this respect to the Helmholtz resonator.

Advantageous configurations of the invention are indicated in the following description and the subclaims, the features of which may be applied individually and in any desired combination.

In one advantageous configuration of the invention, at least one duct may take the form of a purging air duct, with at least one inlet orifice and at least one outlet orifice, such that purging air may flow through the purging air duct.

In this configuration of the invention, the duct is supplied with purging air which is passed through the duct. The purging air may for example be compressor air. The amount of purging air which is consumed in the process may be selected to be significantly less than that consumed in the purging air-purged Helmholtz resonators according to the prior art. In addition, this purging air no longer impairs the performance of the Helmholtz resonator.

It may also be considered advantageous if cooling fluid can flow around at least one duct of the damping device at least in places.

This configuration of the invention has the advantage that the cooling fluid, for example compressor air, continues to be available for combustion. The duct may to this end be guided in places outside an inner combustion chamber housing through a compressor air stream, such that the air brushes past the duct. Irrespective thereof, purging air could however also additionally flow through the duct to increase the cooling effect.

An advantageous configuration of the invention may be provided in that the duct is surrounded at least in places by the resonator housing.

This allows the damping device to have a compact structure. For example, the resonator housing may have an annular cross-section.

It may also be considered advantageous for the duct to extend at least in places through the resonator housing and for the at least one resonator neck tube leading into the duct to lead into the duct in the interior of the resonator housing.

The start of the duct optionally provided with an inlet opening and the at least one outlet orifice of the duct may in this configuration of the invention terminate flush with the resonator housing. The duct could however also extend in another manner through the resonator housing. For example, the duct may project out of the resonator housing. The resonator neck tubes may be configured in one piece with the duct jacketing, said tubes for example comprising orifices in the duct jacketing. The resonator neck tubes may however also be configured otherwise, for example screwed into the duct, such that the damping frequency of the Helmholtz resonator may be easily modified by exchanging the resonator neck tubes. The duct jacketing may for the purposes of the invention also be denoted duct wall.

Provision may moreover advantageously be made for at least one resonator neck tube to be constructed by means of perforation of the duct jacketing.

This development of the invention has particularly low manufacturing costs.

It may also be considered advantageous for the resonator housing to be of cylindrical construction and to surround a duct coaxially at least in places.

This symmetrical construction of the damping device may be arranged particularly simply on a gas turbine.

Provision may moreover advantageously be made for the height of the cylindrical resonator housing to correspond to 20-150% of the cylinder diameter of the resonator housing.

The height of the cylindrical resonator housing may here correspond substantially to the height of the cuboidal resonators in the prior art. At the stated ratio of cylinder diameter and cylinder height, frequencies of over 1000 Hz arising in gas turbines with the conventional resonator heights may be damped, wherein the length of the resonator neck tubes leading into the coaxially surrounding duct is predetermined within limits by the dimensions of the resonator housing. This configuration of the invention is suitable in particular for damping tubular combustion chambers, in which high frequency thermoacoustic combustion oscillations may form.

The duct may advantageously be a cylindrical tube.

This configuration of the duct is particularly simple to produce or, as a standard component, has low manufacturing costs. The resonator neck tubes leading into the duct may lead thereinto for example evenly distributed over a portion of the tubes. They could however also for example lead into the duct only on one side of the tubes along a path extending in the longitudinal direction of the tubes.

Provision may advantageously be made for the area of the outlet orifice of a duct to correspond to one to two times the total cross-sectional area of the resonator neck tubes leading into the duct.

The acoustic transmittance of the duct is in this manner adapted particularly advantageously to the Helmholtz resonator.

It is additionally ensured that, on supply of the duct with purging air, it is possible particularly effectively with a small quantity of purging air to prevent hot gas from being drawn into the purging air duct and thus into the at least one resonator neck tube.

In a further advantageous configuration of the invention, the resonator housing may be configured to lie with a housing wall of the resonator housing on a cold side of a chamber wall or to be configured in one piece therewith, wherein the chamber wall encloses a volume with oscillations to be damped.

To cool the resonator housing wall lying on the chamber wall, cooling air bores set at an angle may be introduced into the resonator housing in such a way as to allow impact cooling of the hot gas-side housing wall.

In a further advantageous configuration of the invention, downstream of the at least one mouth of the resonator neck tubes leading into the duct the duct may extend outside the resonator housing, such that the damping device may be arranged with one end of the duct at a chamber wall, leaving a space between the resonator housing and the chamber wall, wherein the chamber wall encloses a volume with oscillations to be damped.

This configuration has the advantage that the duct may be cooled by means of compressor air flowing past. In this respect, the duct may be flowed around by cooling fluid at least in places.

The configuration has the further advantage that the impact cooling of the resonator housing wall pointing in the direction of the hot side may be far less significant. It could even be completely omitted. Due to the spacing, the resonator housing may also be sufficiently cooled by means of compressor air flowing past, wherein the compressor air is moreover available to the combustion process.

Advantageously, provision may further be made for the damping device to be arrangeable detachably on the chamber wall.

The duct may for example comprise a thread in the region of the outlet orifice, such that the duct may be screwed into an orifice in the chamber wall.

This allows simple exchange of the damping device.

To change the resonant frequency of the damping device, the resonator housing may be connected detachably to the duct for exchange with another resonator housing.

It is a further object of the invention to provide a gas turbine with at least one combustion chamber and at least one damping device of the above-stated type, which allows particularly effective damping of thermoacoustic oscillations.

This object is achieved according to the invention in a gas turbine of the above-stated type in that the damping device is configured as claimed.

It may also be considered advantageous for the damping device to be arranged on a combustion chamber housing of the combustion chamber substantially at the level of a combustion zone.

In this way, the damping device is arranged close to the acoustic source of the thermoacoustic oscillations. This leads to a further increase in the damping effect.

According to one advantageous configuration of the invention, the resonator housing may annularly surround a combustion chamber housing of the combustion chamber.

Advantageously, in this configuration of the invention a plurality of ducts are provided which are for example arranged at regular distances along the circumference of the combustion chamber and support the annular resonator housing at a distance from the combustion chamber.

According to one advantageous configuration of the invention, the average cross-sectional area of the duct between outlet orifice and mouth region of the resonator neck tubes may correspond to two to ten times the sum of the cross-sectional areas of the resonator neck tubes which connect the duct with the resonance volume.

In general, the duct will have a constant cross-section over this section, such that this constant area may be used as a condition.

Due to this condition, the duct does not behave as a resonator neck of the Helmholtz resonator and additionally has dimensions that allow effective cooling.

The criterion should be applied according to the configuration to at least one of the Helmholtz resonators, which is connected fluidically to the duct via the at least one resonator neck tube. It may however also be applied according to one exemplary embodiment to all the Helmholtz resonators which are connected fluidically with the duct via the at least one resonator neck tube. In this case, the duct does not influence the frequency range in any of the resonators.

According to one advantageous configuration of the invention, the duct may be configured as a purging air duct with at least one inlet orifice other than the resonator neck tubes and at least one outlet orifice, such that at least one fraction of the cooling air flowing through the purging air duct may pass into the at least one inlet orifice and into the duct and pass through the duct with omission of the resonance volume.

This configuration has already substantially been described further above in other terms.

According to one advantageous configuration of the invention, the duct may extend at least in places outside the resonator housing at least upstream of the outlet orifice and downstream of the mouth of the at least one resonator neck tube and be capable of being flowed around by cooling air at least in places in this region.

This configuration has already substantially been described further above in other terms.

According to one advantageous configuration of the invention, the damping device may be arranged outside a combustion chamber and leaving a space between the resonator housing and a combustion chamber wall, with one end of the duct comprising the at least one outlet orifice at the combustion chamber wall, such that a compressor air stream flowing past the combustion chamber may flow around the duct at least in places.

This configuration has already substantially been described further above in other terms.

According to one advantageous configuration of the invention, the cross-section of the at least one inlet orifice is smaller than the cross-section of the purging air duct in the region of the inlet orifice.

In this way, the quantity of purging air may be suitably limited.

According to one advantageous configuration of the invention, all the resonator neck tubes leading into the purging air duct may have a smaller cross-section than the duct.

According to one advantageous configuration of the invention, the duct may be substantially closed apart from the at least one resonator neck tube and the at least one outlet orifice.

The duct is thus cooled primarily by at least one duct portion arrangeable in the cooling air stream being flowed around. If any purging air is passed through the tubes, this quantity may be reduced relative to the prior art.

A further object of the invention is to provide a method for damping thermoacoustic oscillations in which at least one Helmholtz resonator damps the oscillations and in the process the oscillations to be damped are injected into at least one resonator neck of the Helmholtz resonator, wherein the method allows particularly effective damping.

The object is achieved according to the invention in the case of such a method in that the oscillations are firstly introduced into a duct and, with cooling of the transmission medium thereof, propagate therein upstream and are injected upstream into the leading-in resonator neck of the Helmholtz resonator.

Purging of the resonator neck may thereby be dispensed with, so improving the damping effect of the Helmholtz resonator.

Advantageously, the transmission medium may be cooled by means of purging air, such that the oscillations are firstly introduced into a purging air duct purged in the opposite direction from the propagation direction thereof and injected upstream into the resonator neck of the Helmholtz resonator leading into the purging air duct.

The purging air may be compressor air.

According to a further advantageous configuration of the invention, the transmission medium may be cooled by a cooling fluid flowing around the duct.

In this configuration of the invention, the duct may additionally also be purged with purging air to increase the cooling effect. Sufficient cooling of the transmission medium may however also be achieved exclusively by means of the duct being flowed around.

Further convenient configurations and advantages of the invention constitute the subject matter of the description of exemplary embodiments of the invention with reference to the figures of the drawings, wherein the same reference numerals refer to identically acting components.

### BRIEF DESCRIPTION OF THE DRAWINGS

In the drawings

FIG. 1 shows a gas turbine according to the prior art,

FIG. 2 is a schematic representation of a first exemplary embodiment of a damping device according to the invention in longitudinal section,

FIG. 3 shows the exemplary embodiment of FIG. 2 in plan view,

FIG. 4 is a schematic representation of a second exemplary embodiment of the damping device according to the invention in longitudinal section,

FIG. 5 is a schematic representation of a third exemplary embodiment of the damping device according to the invention in longitudinal section, and

FIG. 6 shows a portion of a combustion chamber according to the invention with a damping device according to a fourth exemplary embodiment in longitudinal section.

### DETAILED DESCRIPTION OF INVENTION

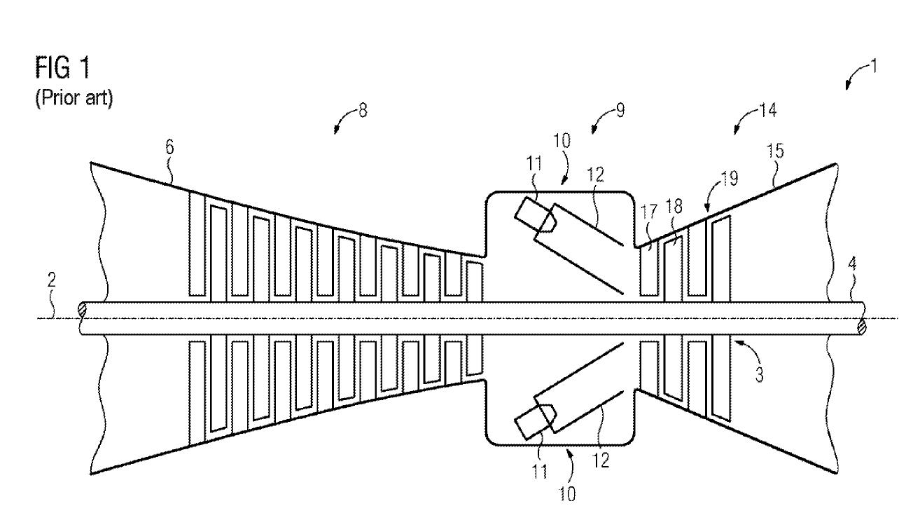

FIG. 1 shows a sectional view of a gas turbine 1 according to the prior art in a schematically simplified representation. In its interior, the gas turbine 1 comprises a rotor 3 mounted so as to rotate about an axis of rotation 2 and having a shaft 4, said rotor also being known as a turbine wheel. The following succeed one another along the rotor 3: an intake housing 6, a compressor 8, a combustion system 9 with a number of tubular combustion chambers 10, which each comprise a burner arrangement 11 and a housing 12, a turbine 14 and a waste gas housing 15.

The combustion system 9 communicates with a for example annular hot gas duct. A plurality of series-connected turbine stages there form the turbine 14. Each turbine stage is formed of rings of blades or vanes. When viewed in the direction of flow of a working medium, a row formed of guide vanes 17 follows a row of rotor blades 18 in the hot duct. The guide vanes 17 are here fastened to an inner housing of a stator 19, whereas the rotor blades 18 of a row are mounted for example by means of a turbine disk on the rotor 3. A generator (not shown) is for example coupled to the rotor 3.

During operation of the gas turbine, air is aspirated by the compressor 8 through the intake housing 6 and compressed. The compressed air provided at the turbine-side end of the compressor 8 is guided to the combustion system 9 and there is mixed with a fuel in the region of the burner arrangement 11. The mixture is then combusted in the combustion system 9 with the assistance of the burner arrangement 11, forming a working gas stream. From there the working gas stream flows along the hot gas duct past the guide vanes 17 and the rotor blades 18. At the rotor blades 18 the working gas stream expands in a pulse-transmitting manner, such that the rotor blades 18 drive the rotor 3 and the latter drives the generator (not shown) coupled thereto.

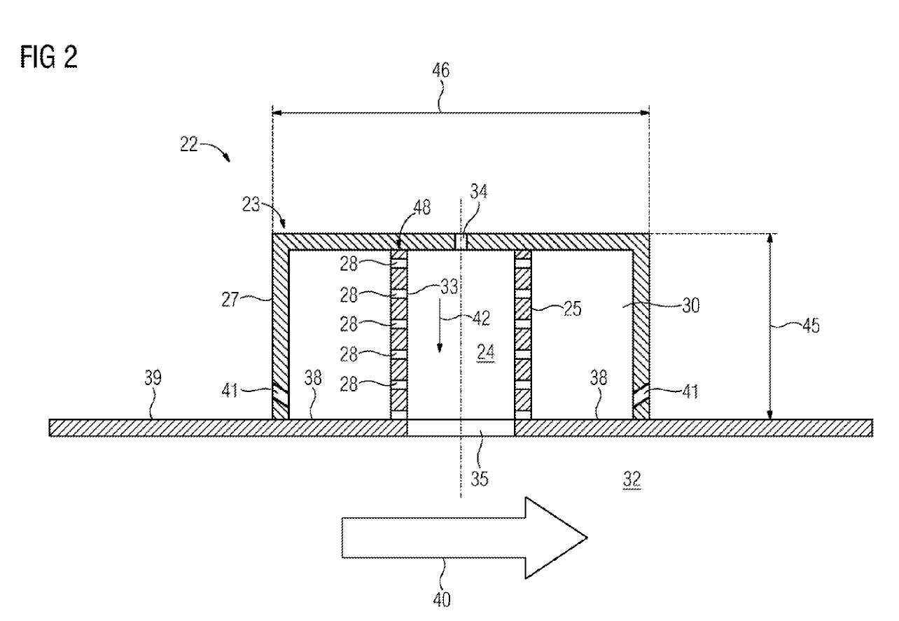

FIG. 2 is a schematic representation of a first exemplary embodiment of a damping device 22 according to the invention in longitudinal section. The damping device 22 comprises a Helmholtz resonator 23 and a duct in the form of a purging air duct 24 with duct jacketing 25. The Helmholtz resonator 23 comprises a cylindrical resonator housing 27, wherein the cylindrical purging air duct 24 extends through the resonator housing 27 and is surrounded coaxially by the resonator housing 27. The resonator housing 27 encloses the resonance volume 30 of the Helmholtz resonator. A plurality of cylindrical resonator neck tubes 28 extend through the duct jacketing 25 of the purging duct 24. The resonator neck tubes 28 lead into the purging air duct 24 in the interior of the resonator housing 27. In this case the resonator neck tubes 28 are arranged such that they lead into the purging air duct 24 on the hot gas side—i.e. with their hot-gas-side output 33—downstream of an inlet orifice 34 of the purging air duct and upstream of the one outlet orifice 35 of the purging air duct 24. The resonator housing 27 comprises a housing wall 38, which is in one piece with a chamber wall 39. The chamber wall 39 here encloses a volume with oscillations to be damped, which is enclosed by the environment 32 to be damped of the Helmholtz resonator.

The chamber wall 39 illustrated comprises a combustion chamber housing, wherein a hot working gas stream 40 flows in the combustion chamber. The hot working gas stream 40 corresponds to a fluid stream flowing through a burner plenum and a combustion chamber and designated in the combustion chamber portion as hot working gas stream 40. To cool the housing wall 38, cooling ducts 41 may be introduced into the resonator housing 27. The thermoacoustic oscillations in the combustion chamber arising during combustion are injected into the Helmholtz resonator 23 by the resonator neck tubes 28 and are damped therein. The purging air flowing in the purging air duct 24 in the direction 42 reliably prevents hot gas from being drawn in. The velocity of the purging air in the purging air duct 24 does not here influence the velocity of the injected acoustic oscillations in the resonator neck tubes 28, such that the performance of the Helmholtz resonator 23—i.e. the damping action thereof—is unaffected by the velocity of the purging air exiting from the outlet orifice 35. In the illustrated exemplary embodiment of the damping device 22, the hot-gas-side end of the purging air duct 24 is formed in one piece with the chamber wall 39 in the region of the outlet orifice 35. The highly compact construction of the damping device 22 may be further simplified in that the resonator neck tubes 28 are formed by means of perforations in the duct wall 25 of the purging air duct 24. This one-piece configuration of the resonator neck tubes with the purging air duct 24 makes it possible further to reduce the manufacturing costs of the damping device 22. The height 45 of the cylindrical resonator housing 27 corresponds to 20-150% of the cylinder diameter 46 of the resonator housing 27. So as to be able to adapt the resonator housing 27 or the resonance volume 30 enclosed thereby to a frequency band of oscillations to be damped, the resonator housing 27 may be connected detachably to the purging air duct 24 in the region 48.

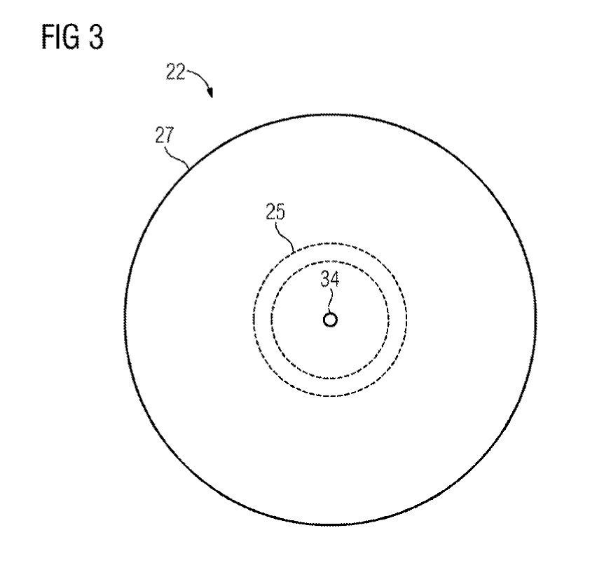

FIG. 3 shows the damping device 22 illustrated in FIG. 2 in plan view. The cylindrical resonator housing 27 comprises the inlet orifice 34 of the purging air duct 24 at its top. The profile of the duct jacketing 25 of the purging air duct is indicated with broken lines.

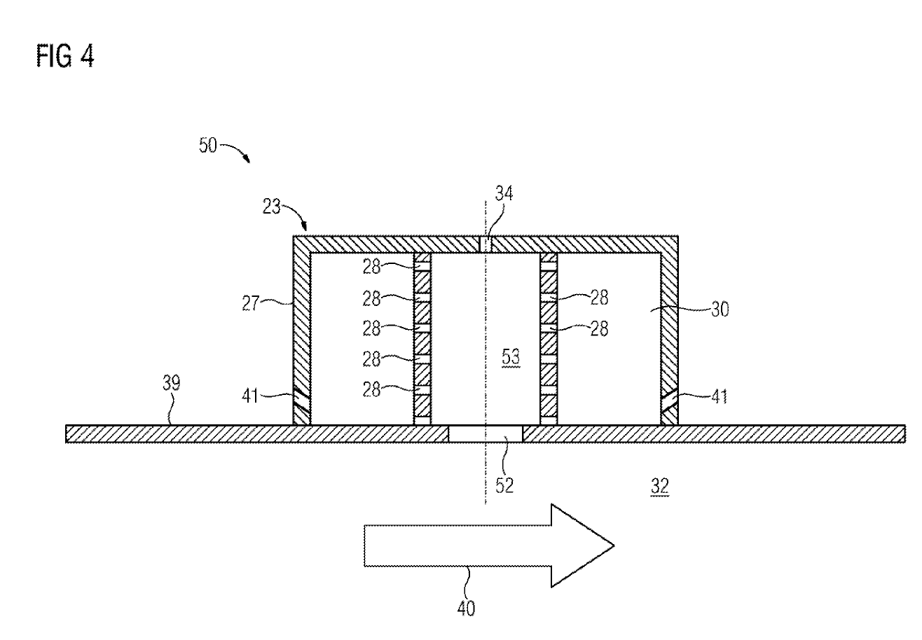

FIG. 4 shows a second exemplary embodiment of a damping device 50 according to the invention. This has a smaller cross-section of the outlet orifice 52 of the purging air duct 53 than the exemplary embodiment shown in FIG. 2. The cross-sectional area of the outlet orifice 52 of the purging air duct here corresponds to 1 to 2 times the total cross-sectional area of the resonator neck tubes 28 leading into the purging air duct 53. This makes it possible reliably to prevent hot air from being drawn in while purging air consumption is kept low.

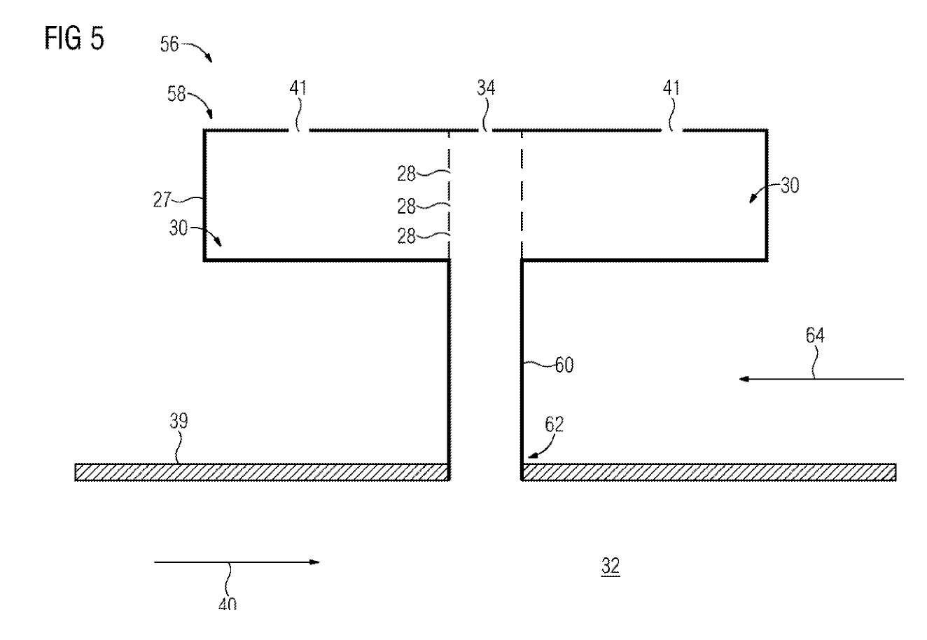

FIG. 5 shows a third exemplary embodiment of a damping device 56 according to the invention with a Helmholtz resonator 58 and a duct 60. Unlike in the first and second exemplary embodiments, downstream of the at least one mouth of the resonator neck tubes 28 leading into the purging air duct 60 the duct 60 extends outside the resonator housing 27. The damping device 56 is arranged with one end 62 of the duct 60 at a chamber wall 39, leaving a space between the resonator housing 27 and the chamber wall 39, wherein the chamber wall 39 encloses a volume with oscillations to be damped. In this way, the Helmholtz resonator may be cooled by compressor air flowing for example in direction 64. The cooling ducts 41 additionally arranged in the resonator housing 27 may in this case also be omitted. The damping device 56 may be fastened detachably to the chamber wall 39, for example by means of a thread formed on the duct 60 in the region of the end 62.

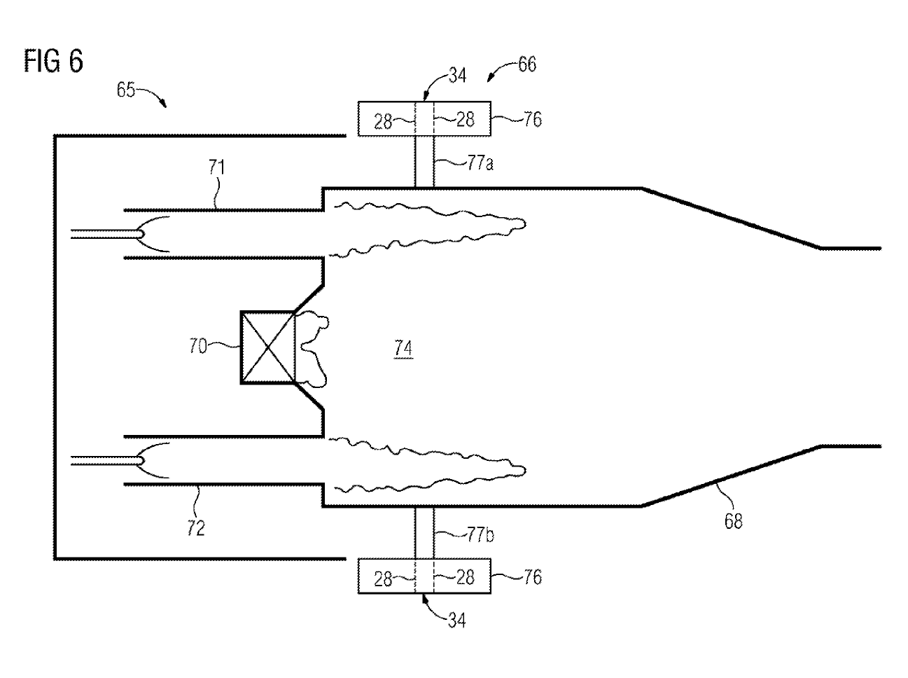

FIG. 6 shows a longitudinal section through a portion of a gas turbine combustion chamber 65 with a damping device 66 according to the invention corresponding to a fourth exemplary embodiment.

The figure is a simplified, schematic diagram of the combustion chamber. The gas turbine combustion chamber 65 comprises a rotationally symmetrical combustion chamber housing 68, at the upstream end of which a pilot burner 70 and two main burners 71, 72 are arranged. The damping device 66 is arranged on the combustion chamber 65 at the level of a combustion zone 74. The resonator housing 76 of the damping device 66 extends annularly around the combustion chamber housing 68, wherein a plurality of ducts 77a, 77b support the resonator housing 76. Compressor air flows around the ducts 77a, 77b, which are thus supplied with a cooling fluid.

1.-27. (canceled)

28. A damping device for a gas turbine comprising:
at least one Helmholtz resonator and
at least one duct,
wherein the Helmholtz resonator comprises a resonator housing and at least one resonator neck tube, and the resonator housing encloses a resonance volume of the Helmholtz resonator into which acoustic oscillations may be injected by the resonator neck tube, and
wherein the duct has a duct jacketing and at least one outlet orifice, wherein acoustic oscillations of a fluid stream flowing through a burner plenum and a combustion chamber may be injected into the outlet orifice and
wherein the duct may be supplied with a cooling fluid,
wherein the at least one resonator neck tube leads into such a duct on the hot gas side upstream of the at least one outlet orifice,
wherein the duct is surrounded at least in places by the resonator housing and the at least one resonator neck tube leading into the duct leads into the duct in the interior of the resonator housing,
wherein at least one duct takes the form of a purging air duct with at least one inlet orifice other than the resonator neck tubes and at least one outlet orifice, such that the cooling air flowing through the purging air duct may pass into the at least one inlet orifice and into the duct and pass through the duct with omission of the resonance volume,
wherein the resonator housing is of cylindrical construction and surrounds a duct coaxially at least in places,
wherein the height of the cylindrical resonator housing corresponds to 20-150% of the cylinder diameter of the resonator housing.

29. The damping device for a gas turbine as claimed in claim 28,
wherein the resonator housing is configured to lie with a housing wall of the resonator housing on a cold side of a chamber wall or to be configured in one piece therewith, wherein the chamber wall encloses a volume with oscillations to be damped.

30. A damping device for a gas turbine comprising:
at least one Helmholtz resonator and
at least one duct,
wherein the Helmholtz resonator comprises a resonator housing and at least one resonator neck tube, and the resonator housing encloses a resonance volume of the Helmholtz resonator into which acoustic oscillations may be injected by the resonator neck tube, and
wherein the duct has a duct jacketing and at least one outlet orifice, wherein acoustic oscillations of a fluid stream flowing through a burner plenum and a combustion chamber may be injected into the outlet orifice, and
wherein the duct may be supplied with a cooling fluid,
wherein the at least one resonator neck tube leads into such a duct on the hot gas side upstream of the at least one outlet orifice,
wherein the duct is surrounded at least in places by the resonator housing and the at least one resonator neck tube leading into the duct leads into the duct in the interior of the resonator housing,
wherein the damping device is arranged outside a combustion chamber and leaves a space between the resonator housing and a combustion chamber wall, with one end of the duct comprising the at least one outlet orifice at the combustion chamber wall, such that a compressor air stream flowing past the combustion chamber may flow around the duct at least in places.

31. The damping device as claimed in claim 30,
wherein at least one duct is configured as a purging air duct with at least one inlet orifice other than the resonator neck tubes and at least one outlet orifice, such that at least one fraction of the cooling air flowing through the purging air duct may pass into the at least one inlet orifice and into the duct and pass through the duct, with omission of the resonance volume, such that purging air may flow through the purging air duct.

32. The damping device as claimed in claim 30,
wherein the duct is substantially closed apart from the at least one resonator neck tube and the at least one outlet orifice.

33. The damping device for a gas turbine as claimed in claim 30,
wherein at least one resonator neck tube is formed by perforations in the duct jacketing of a duct.

34. The damping device for a gas turbine as claimed in claim 30,
wherein the duct is a cylindrical tube.

35. The damping device for a gas turbine as claimed in claim 30,
wherein the area of the outlet orifice of a duct corresponds to 1 to 2 times the total cross-sectional area of the resonator neck tubes leading into the duct.

36. The damping device for a gas turbine as claimed in claim 30,
wherein the damping device is adapted to be arranged detachably on the chamber wall.

37. The damping device for a gas turbine as claimed in claim 30,
wherein the resonator housing is connected detachably to the duct.

38. The damping device as claimed in claim 30,
wherein the average cross-sectional area of the duct between outlet orifice and mouth region of the resonator neck tubes corresponds to two to ten times the sum of the cross-sectional areas of the resonator neck tubes which connect the duct with the resonance volume.

39. The damping device as claimed in claim 30,
wherein the cross-section of the at least one inlet orifice is smaller than the cross-section of the purging air duct in the region of the inlet orifice.

40. The damping device as claimed in claim 30,
wherein all the resonator neck tubes leading into the purging air duct may have a smaller cross-section than the duct.

41. A gas turbine, comprising
at least one combustion chamber, and
at least one damping device, wherein the damping device is configured as claimed in claim 30.

42. The gas turbine as claimed in claim 41,
wherein the damping device is arranged on a combustion chamber housing of the combustion chamber substantially at the level of a combustion zone.

43. The gas turbine as claimed in claim 41,
wherein the resonator housing annularly surrounds a combustion chamber housing of the combustion chamber.

44. A gas turbine, comprising
at least one combustion chamber, and
at least one damping device, wherein the damping device is configured as claimed in claim 28.

45. The gas turbine as claimed in claim 44,
wherein the damping device is arranged on a combustion chamber housing of the combustion chamber substantially at the level of a combustion zone.

46. The gas turbine as claimed in claim 44,
wherein the resonator housing annularly surrounds a combustion chamber housing of the combustion chamber.
